(19) United States
(12) Patent Application Publication
(10) Pub. No.: US 2024/0166922 A1
(43) Pub. Date: May 23, 2024

(54) RUBBERIZED ASPHALT COMPOSITION WITH ACRYLIC COPOLYMER

(71) Applicant: BASF SE, Ludwigshafen am Rhein (DE)

(72) Inventors: Singa D. TOBING, Southfield, MI (US); William J. KIRK, Charlotte, NC (US); Hiruy YIGEZU, Charlotte, NC (US)

(21) Appl. No.: 18/283,474

(22) PCT Filed: Mar. 23, 2022
(86) PCT No.: PCT/US2022/021577

§ 371 Date: Sep. 22, 2023

Related U.S. Application Data
(60) Provisional application No. 63/166,693, filed on Mar. 26, 2021.

(51) Int. Cl. C09J 7/38; C09J 7/24; E04D 12/00

(52) U.S. Cl. CPC C09J 7/385; C09J 7/243; E04D 12/002; C09J 2203/346; C09J 2301/414; C09J 2400/166; C09J 2423/046; C09J 2433/00; C09J 2495/00

(57) ABSTRACT

Disclosed is composition and in particular a rubberized asphalt composition comprising asphalt, an elastomeric polymer, and an acrylic copolymer, a method to make the composition and uses thereof, useful in roofing underlayment. The underlayment products have improved adhesion at low temperatures.

### FIELD OF THE INVENTION

This invention pertains to compositions comprising asphalt, an elastomeric polymer, and an acrylic copolymer, a method to make the composition and uses thereof.

### BACKGROUND OF THE INVENTION

The present invention relates to a rubberized asphalt compositions useful for roof underlayment, and process for producing same.

Rubberized asphalt compositions are used in the construction industry to adhere shingles to a roofing structure. These compositions offer protection to the roof from the environment, particularly in the form of a waterproof barrier. Using rubberized asphalt compositions for this purposed is well known in the art.

Roofing shingles are typically delivered to a construction site, transferred to the roof, unpacked from the bundle, positioned and adhesively secured to roof substrate. The roof substrate to which the shingles are secured may be one of a variety of materials depending on the installation site and structural concerns. For example, the surface may be a concrete, metal, gypsum, plywood, or wood deck, it may include insulation or recover board, and/or it may be adhered to an existing layer of shingles.

An underlayment material is commonly used in a number of roofing applications as well as other underlayment situations. The typical product utilized in roofing underlayment is commonly referred to as “tar” of “felt” paper. The traditional “tar paper” is an asphalt impregnated product which is sold in a roll; unrolled on a roof; cut to length; and fastened to the roof utilizing staples or nails. Although tar paper is inexpensive, it does not seal nail holes through the paper and thus does not prevent water infiltration. In addition, once the felt is rolled out, it absorbs water and once wet, it wrinkles and expands, and must be allowed to dry out before covering with shingles. Today, rubberized asphalt is widely used in roofing applications as underlayment, and as a sealant for shingles in particular, to prevent water infiltration of the roofing structure. In many applications underlayment, laminates or membranes containing a rubberized asphalt or modified asphalt are used.

For most residential applications, underlayment is laid on the inclining surface of a, for example, wooden support deck and nailed to it. However, the nails puncture the underlayment and leaks can occur around the nail punctures. Currently, asphalt is applied over the nail heads to act as a sealant to prevent water seepage of rain water through the punctured underlayment. This practice is labor intensive and adds to the time and expense of installing a roof.

These prior applications, however, have inherent limitations. The waterproofing properties of underlayment are very much dependent on the quality of the asphalt used. Prolonged exposure to the environment and exposure to low temperatures may result in hardening of asphalt. It has become apparent that even rubberized asphalt compositions have very poor adhesion once the ambient temperature falls below about 5° C., resulting in water penetration. This phenomenon is readily observed during spring time snow melt, and often referred to leakage of the “ice dam.”

Accordingly, there is a need for rubberized asphalt or modified asphalt compositions and underlayment products that have improved adhesion at low temperatures, thus avoiding leakage of the “ice dam,” are low cost, heavyweight or lightweight, dimensionally stable and/or elongate and recover to seal nail holes and other punctures.

### BRIEF SUMMARY OF THE INVENTION

It was an object of the invention to develop a rubberized asphalt composition comprising asphalt, an elastomeric polymer, and an acrylic copolymer, having improved adhesion at low temperatures.

The following are embodiments of the invention:

Embodiment 1. A composition comprising: an acrylic copolymer, an clastomeric polymer, and asphalt.

Embodiment 2. The composition of embodiment 2, wherein the elastomeric polymer is thermoplastic elastomer.

Embodiment 3. The composition of embodiment 2, wherein elastorneric polymer is selected from the group consisting of styrene-butadiene copolymer, styrene-butadiene rubber, Polyethylene/polypropylene, ethylene acrylate copolymer, ethyl-vinyl-acetate (EVA), polyvinyl chloride (PVC), ethylene propylene, Polychloroprene latex, natural latex, and polyolefins.

Embodiment 4. The composition of embodiment 1-3, wherein the asphalt has a penetration of from 30 to 300 determined according to ASTM D5.

Embodiment 5. The composition of embodiment 1-4, wherein the composition comprises from 5% to 20% by weight elalonieric polymer, from 60% to 90% by weight asphalt, and from 5% to 20% by weight acrylic copolymer, based on total weight of the composition.

Embodiment 6. The composition of embodiment 1-5, wherein the acrylic copolymer is based on a polymerization of a monomer A, a monomer B, and a monomer C.

Embodiment 7. The composition of embodiment 1-6, wherein the acrylic copolymer has a weight average molecular weight Mw of from 150,000 to 250,000.

Embodiment 8. The composition of embodiment 1-7, wherein the acrylic copolymer has a number average molecular weight Mn of from 20,000 to 50,000.

Embodiment 9. The composition of embodiment 1-8, wherein the acrylic copolymer has a dispersity of from 5 to 11.

Embodiment 10. The composition of embodiment 6, wherein monomer A includes methyl, ethyl, propyl, isoamyl, isooctyl, n-butyl, isobutyl, tert-butyl, cyclohexyl, 2-ethylhexyl, decyl, lauryl or stearyl acrylate and/or methacrylate.

Embodiment 11. The composition of embodiment 6, wherein monomer B includes acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and -methacrylamide, maleic acid monoamide and diamide, itaconic acid monoamide and diamide, fumaric acid monoamide and diamide, vinylsulfonic acid or vinylphosphonic acid.

Embodiment 12. The composition of embodiment 6, wherein monomer C includes N,N-dimethylaminoethyl- and N,N-diethylaminoethyl(meth)-acrylamide,N,N-diisopropyl(meth)acrylamide,N,N-dibutyl(meth)acrylamide, N,N-dimethylaminoethyl (meth)acrylate and N,N-diethylaminoethyl (meth)acrylate, dimethyl- and diethylaminoethyl vinyl ether, N-vinylimidazole, N-vinylimidazoline, vinylpyridines, dialkyl(meth)acrylamides, N-vinylformamide, N-vinylpyrrolidone, N-vinylcaprolactam, p-hydroxy(meth)acrylic acid anilide, N-tert-butyl(meth)-acrylamide, diacetone(meth)acrylamide, N-(1-methylundecyl) (meth)acrylamide, N-isobornyl(meth)acrylamide, N-adamantyl(meth)acrylamide, N-benzyl(meth)acrylamide, N-4-methylphenyl(meth)acrylamide, methyl(meth)acrylamide, N-diphenylmethylacrylamide, phthalimidomethyl(meth)acrylamide, (meth)acrylamidohydroxyacetic acid, (meth)acrylamidoacetic acid, (meth)acrylamidoacetic esters, such as methyl (meth)acrylamidoacetate, 2-(meth)acrylamido-2-methylbutyric acid, N-(2,2,2-trichloro-1-hydroxy)-ethyl(meth)acrylamide, N,N-bis-(2-cyanoethyl)-methacrylamide, N-(1,1,1-trishydroxymethyl)(meth)acrylamide, methyl-(meth)acrylamide and N-(3-hydroxy-2,2-dimethylpropyl)(meth)acrylamide, 2-hydroxy-3-[N,N-di-(2-hydroxyethyl)]-propyl (meth)acrylate, 2-methoxy-3-[N,N-di-(2-hydroxyethyl)]-propyl (meth)acrylate, 2-hydroxy-3-[N-hydroxyethyl-N-alkyl]-propyl (meth)acrylates, 2-hydroxy-3-[N,N-dialkyl]-propyl (meth)acrylate, 2-hydroxy-3[N-hydroxyethyl-N-methyl]-propyl (meth)acrylate and 2-hydroxy-3-[N-ethyl-N-methyl]-propyl(meth)acrylate, 3-cyclohexylprop-1-yl (meth)acrylate, cyclohexyl (meth)acrylate, 4-tert-butylcyclohexyl (meth)acrylate, 2-N-morpholinoethyl (meth)acrylate, 2-N-morpholinohexyl (meth)acrylate, furfuryl (meth)acrylate, isobornyl (meth)acrylate, N-cyclohexyl(meth)acrylamide and N-isobornyl(meth)acrylamide.

Embodiment 13. The composition of embodiment 6, wherein the monomer A is selected from the group consisting of 2-ethylhexyl acrylate, butyl acrylate, and isooctyl acrylate, wherein the acrylate monomer has a Tg of less than −30 C by DSC, in an amount of from 50% by weight to 99.99% by weight.

Embodiment 14. The composition of embodiment 6, wherein the monomer B is selected from the group consisting of acrylic acid, methacrylic acid, and itaconic acid, in an amount of from 0.1% by weight to 10% by weight.

Embodiment 15. The composition of embodiment 6, wherein the monomer C is selected from the group consisting of glycidyl methacrylate, maleated acrylate, and hydroxyl ethyl acrylate, in an amount of from 0.1% by weight to 25% by weight.

Embodiment 16. An underlayment comprising a substrate and an acrylic copolymer and a binder.

Embodiment 17. The underlayment of embodiment 16, further comprising a release liner.

Embodiment 18. The underlayment of embodiment 16 or 17, wherein the substrate is selected from the group consisting of nonwoven polypropylene, nonwoven polyethylene, nonwoven polyethylene terephthalate, woven polypropylene, woven polyethylene, spunbond polypropylene, spunbond polyester, and combinations thereof.

Embodiment 19. The composition of embodiment 1-15, where the composition is characterized by a peel strength, when adhered to a stainless steel panel and tested according to PSTC 101, of at least 5 psi.

Embodiment 20. A roof assembly comprising the underlayment of embodiment 16 to 18.

Embodiment 21. A process for producing composition of embodiment 1 comprising mixing the elastomeric polymer and the asphalt at a temperature above about 150° C. at a high shear rate for a duration of more than 1 hour to produce a rubberized asphalt mixture, reducing the temperature of the rubberized asphalt mixture to a temperature of about 140° C., mixing, at a low shear rate for a duration of more than 10 min, the acrylic copolymer to the rubberized asphalt mixture to form an rubberized asphalt blend.

Embodiment 22. The process of embodiment 21, wherein the rubberized asphalt blend comprises from 5% to 20% elatorneric polymer, from 60% to 90% asphalt, and from 5% to 20% acrylic copolymer, based on total weight of the rubberized asphalt blend.

Embodiment 23. The process of embodiment 21 or 22, wherein the acrylic copolymer is based on a polymerization of a monomer A, a monomer B, and a monomer C.

Embodiment 24. The process of embodiment 21-23, wherein the acrylic copolymer has a weight average molecular weight Mw of from 150,000 to 250,000.

Embodiment 25. The process of embodiment 21-24, wherein the acrylic copolymer has a number average molecular weight Mn of from 20,000 to 50,000.

Embodiment 26. The process of embodiment 21-25, wherein the acrylic copolymer has a dispersity of from 5 to 11.

Embodiment 27. The process of embodiment 23, wherein the monomer A is selected from the group consisting of 2-ethylhexyl acrylate, butyl acrylate, and isooctyl acrylate, wherein the acrylate monomer has a Tg of less than −30 C by DSC, in an amount of from 50% by weight to 99.99% by weight.

Embodiment 28. The process of embodiment 23, wherein the monomer B is selected from the group consisting of acrylic acid, methacrylic acid, and itaconic acid, in an amount of from 0.1% by weight to 10% by weight.

Embodiment 29. The process of embodiment 23, wherein the monomer C is selected from the group consisting of glycidyl methacrylate, maleated acrylate, and hydroxyl ethyl acrylate, in an amount of from 0.1% by weight to 25% by weight.

The foregoing embodiments are just that and should not be read to limit or otherwise narrow the scope of any of the inventive concepts otherwise provided by the instant disclosure. While multiple embodiments are disclosed, still other embodiments will become apparent to those skilled in the art from the following detailed description, which shows and describes illustrative examples. Accordingly, the drawings and detailed description are to be regarded as illustrative in nature rather than restrictive in nature.

### DETAILED DESCRIPTION OF THE INVENTION

The following examples further illustrate the invention but, of course, should not be construed as in any way limiting its scope. Provided herein are compositions comprising an acrylic resin and a binder, and in particular rubberized asphalt composition comprising asphalt, an elastomeric polymer, and an acrylic copolymer, and multilayer composites or underlayment, particularly useful as roofing membranes.

“Copolymer” refers to polymers containing two or more monomers.

The compositions comprise asphalt, an elastomeric polymer, and an acrylic copolymer, each component described in detail below. The composition may also include an acrylic copolymer and a binder. The compositions maybe used in underlayment, particularly useful as roofing membranes,

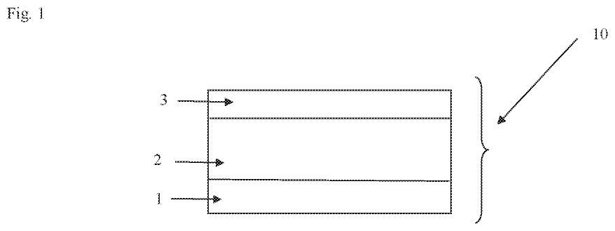

FIG. 1 shows underlayment 10, which may be referred to as a membrane 10. underlayment 10 includes a substrate 1, a rubberized asphalt composition layer 2, and a release liner 3 removably attached to layer 2.

Acrylic Copolymer

According to various embodiments described herein, the acrylic copolymer maybe based on a polymerization of a monomer A. a monomer B. and a monomer C.

According to various embodiments described herein, monomer A may include methyl, ethyl, propyl, isoamyl, isooctyl, n-butyl, isobutyl, tert-butyl, cyclohexyl, 2-ethylhexyl, decyl, lauryl or stearyl acrylate and/or methacrylate.

According to various embodiments described herein, monomer A may have a Tg of less than −30 C by DSC.

According to various embodiments described herein, monomer B may include acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and -methacrylamide, maleic acid monoamide and diamide, itaconic acid monoamide and diamide, fumaric acid monoamide and diamide, vinylsulfonic acid or vinylphosphonic acid.

According to various embodiments described herein, monomer C may include N,N-dimethylaminoethyl- and N,N-diethylaminoethyl(meth)-acrylamide,N,N-diisopropyl(meth)acrylamide,N,N-dibutyl(meth)acrylamide, N,N-dimethylaminoethyl (meth)acrylate and N,N-diethylaminoethyl (meth)acrylate, dimethyl- and diethylaminoethyl vinyl ether, N-vinylimidazole, N-vinylimidazoline, vinylpyridines, dialkyl(meth)acrylamides, N-vinylformamide, N-vinylpyrrolidone, N-vinylcaprolactam, p-hydroxy(meth)acrylic acid anilide, N-tert-butyl(meth)-acrylamide, diacetone(meth)acrylamide, N-(1-methylundecyl) (meth)acrylamide, N-isobornyl(meth)acrylamide, N-adamantyl(meth)acrylamide, N-benzyl(meth)acrylamide, N-4-methylphenyl(meth)acrylamide, methyl(meth)acrylamide, N-diphenylmethylacrylamide, phthalimidomethyl(meth)acrylamide, (meth)acrylamidohydroxyacetic acid, (meth)acrylamidoacetic acid, (meth)acrylamidoacetic esters, such as methyl (meth)acrylamidoacetate, 2-(meth)acrylamido-2-methylbutyric acid, N-(2,2,2-trichloro-1-hydroxy)-ethyl(meth)acrylamide, N,N-bis-(2-cyanoethyl)-methacrylamide, N-(1,1,1-trishydroxymethyl)(meth)acrylamide, methyl-(meth)acrylamide and N-(3-hydroxy-2,2-dimethylpropyl)(meth)acrylamide, 2-hydroxy-3-[N,N-di-(2-hydroxyethyl)]-propyl (meth)acrylate, 2-methoxy-3-[N,N-di-(2-hydroxyethyl)]-propyl (meth)acrylate, 2-hydroxy-3-[N-hydroxyethyl-N-alkyl]-propyl (meth)acrylates, 2-hydroxy-3-[N,N-dialkyl]-propyl (meth)acrylate, 2-hydroxy-3[N-hydroxyethyl-N-methyl]-propyl (meth)acrylate and 2-hydroxy-3-[N-ethyl-N-methyl]-propyl(meth)acrylate, 3-cyclohexylprop-1-yl (meth)acrylate, cyclohexyl (meth)acrylate, 4-tert-butylcyclohexyl (meth)acrylate, 2-N-morpholinoethyl (meth)acrylate, 2-N-morpholinohexyl (meth)acrylate, furfuryl (meth)acrylate, isobornyl (meth)acrylate, N-cyclohexyl(meth)acrylamide and N-isobornyl(meth)acrylamide.

The acrylic copolymer can be prepared by known processes.

The weight average molecular weight (Mw) of the acrylic copolymer can be, for example, 150,000 Da or more (e.g., 160,000 Da or more, 170,000 Da or more, 180,000 Da or more, 190,000 Da or more, 200,000 Da or more, 200,000 Da or more, 210,000 Da or more, 220,000 Da or more, 230,000 Da or more, 240,000 Da or more). In some examples, the weight average molecular weight (Mw) of the acrylic copolymer can be 250,000 Da or less (e.g., 240,000 Da or less, 230,000 Da or less, 220,000 Da or less, 210,000 Da or less, 200,000 Da or less, 190,000 Da or less, 180,000 Da or less, 170,000 Da or less, 160,000). The weight average molecular weight (M w) of the acrylic copolymer can range from any of the minimum values described above to any of the maximum values described above. For example, the weight average molecular weight (M w) of the acrylic copolymer can be from 150,000 Da to 250,000 Da (e.g., from 170,000 Da to 220,000 Da, or from 190,000 Da to 200,000 Da,). The weight average molecular weight (M w) of the acrylic copolymer can be determined by GPC (gel permeation chromatography).

The number average molecular weight (M.) of the acrylic copolymer can be, for example, 20,000 or more (e.g., 30,000 or more, or 40,000 or more). In some examples, the number average molecular weight (M.) of the acrylic copolymer can be 50,000 or less (e.g., 40,000 or less, or 30,000 or less). The number average molecular weight (M.) of the acrylic copolymer can range from any of the minimum values described above to any of the maximum values described above. For example, the number average molecular weight (M.) of the acrylic copolymer can be from 20,000 to 50,000 (e.g., from 30,000 to 50,000, or from 40,000 to 50,000). The number average molecular weight (M.) of the acrylic copolymer can be determined by GPC (gel permeation chromatography).

The dispersity DM calculated as Mw/M. where Mw is the mass-average molar mass (or molecular weight) and M. is the number-average molar mass (or molecular weight) of the acrylic copolymer may be more than 5 (e.g., more than 6, or more than 7, or more than 8, or more than 9 or more than 10). The dispersity of the acrylic copolymer may be less than 11 (e.g., less than 10, less than 9, less than 8, less than 7, or less than 6). The dispersity of the acrylic copolymer can range from any of the minimum values described above to any of the maximum values described above. For example, the dispersity of the acrylic copolymer can be from 5 to 11, or from 7 to 9.

Asphalt and Elastomeric Polymer

According to various embodiments described herein, the asphalt may comprise bitumens, which occur in nature or are obtained from petroleum through various refining processes. The asphalt may also comprise modifiers, generally known in the art, such as styrene-butadiene copolymer, styrene-butadiene rubber, Polyethylene/polypropylene, ethylene acrylate copolymer, ethyl-vinyl-acetate (EVA), polyvinyl chloride (PVC), ethylene propylene, Polychloroprene latex, natural latex and polyolefins. Modified bitumens are disclosed for examples in pregnant publication US2019017754, which is incorporated herein by reference in its entirety, especially for the compositions of bitumens disclosed therein.

The asphalt may have a penetration of from 30 to 300 determined according to ASTM D5. The asphalt may be a binder.

According to various embodiments described herein, the composition may comprises an elastomeric polymer. The elastomeric polymer may be a thermoplastic elastomer, such as for example, styrene-butadiene copolymer or styrene-butadiene rubber.

Useful binders and/or asphalt modifiers commercially available. For example, binders and/or asphalt modifiers include those available from Kraton and BASF.

According to various embodiments described herein, the composition may comprise from 60% to 90% by weight asphalt, from 5% to 20% by weight elastomeric polymer, and from 5% to 20% by weight acrylic copolymer, based on total weight of the composition.

Underlayment

The roofing underlayment comprises a composition layer positioned on a substrate wherein the composition comprises an acrylic copolymer and a binder. The composition may also include

In one or more embodiments, the substrate may be polyethylene terephthalate (PET) or polyethylene (PE) film, woven and non-woven polypropylene (PP) and high-density polyethylene (HDPE), non-woven PET, spunbond PP and PET for preparing multilayer structures for use as a roof underlayment. These substrates may be flexible, rollable, or in sheet form.

The substrate is not particularly limited in its thickness. However, for commercial applications, and particularly for those in the roofing industry, the substrate has a thickness of from about 0.1 mm to about 10 mm, from about 0.1 mm to about 5 mm, or from about 0.1 to about 1 mm

Release Liner

According to various embodiments described herein, the release liner may be a polymeric film or extrudate based on polypropylene, polyester, high-density polyethylene, medium-density polyethylene, low-density polyethylene, polystyrene or high-impact polystyrene, or a cellulosic substrate. It is known in the art that a coating or layer may be applied to the film and/or cellulosic substrate, and that it may include a silicon-containing or fluorine-containing coating. These coatings include, for example, silicone oil, polysiloxane or hydrocarbon waxes.

According to various embodiments described herein, the release liner may have a thickness of from 50 μm to 500 μm.

Preparation of Compositions and Underlayments

The compositions of the present invention may be prepared by conventional techniques and from commercially available components. For example, acrylic copolymers useful in the instant compositions include those available from companies such as BASF, and which are offered under a variety of tradenames. Similarly, binders useful in the instant compositions may include those available from Kraton Corporation, and which are offered under a variety of tradenames.

The underlayments of the present invention may be prepared by conventional techniques and commercially available. For example, substrates useful in the instant underlayments include those available from companies such as GCP Applied Technologies, Certain Teed, WR Meadows, and which are offered under a variety of tradenames.

According to various embodiments described herein, the composition is mixed of from about 120 to about 160° C., in other embodiments from about 125 to about 155° C., and in other embodiments from about 130 to about 150° C.

Characteristics of the Composition/Underlayment

According to various embodiments described herein, a layer of the composition disposed on a surface of a substrate may be characterized by an advantageous peel strength.

In one or more embodiments, a layer of the composition disposed on a surface of a substrate may be characterized by an advantageous dead load shear.

Application to a Roof Surface

The underlayment of the present invention can advantageously be applied to a roof surface (also known as roof substrate) by using standard peel and stick techniques. These techniques are generally known to a person of skill in the art. For example, the underlayment can be unrolled on a roof surface and placed into position. The underlayment can then subsequently be adhered to the roof surface by using various techniques, for waterproofing purposes prior to placing shingles on top of the underlayment.

It has advantageously been discovered that compositions of the present invention used in underlayment provide superior adhesion, thus avoiding delamination of roofing underlayment at low temperature. In particular for residential roofing applications, such as shingles, the improved rubberized asphalt formulation can seal the shingles at lower temperature and avoid roof leakage.

### EXAMPLES

This example demonstrates the advantages and performance characteristics of the present invention.

The following materials were used to make the examples:

Asphalt 58-28, KRATON™ D1118, obtained from Kraton Coopretaion, and acResin® DS3532, acResin® A-250, and acResin® A-204, obtained from BASF Corporation.

### Example 1

A mixture of 75 parts by weight (pbw) and 15 pbw KRATON™ D1118 is mixed at temperature of 160° C. at a high shear rate for a duration of 2 hours to produce a rubberized asphalt mixture. Then, the temperature of the rubberized asphalt mixture was reduced to 140° C., and 10 pbw of acResin® DS3532 was stirred into the mixture at a low shear rate for a duration of 15 min, forming the rubberized asphalt blend.

### Example 2

A mixture of 75 parts by weight (pbw) and 15 pbw KRATON™ D1118 is mixed at temperature of 160° C. at a high shear rate for a duration of 2 hours to produce a rubberized asphalt mixture. Then, the temperature of the rubberized asphalt mixture was reduced to 140° C., and 10 pbw of acResin® A-250 was stirred into the mixture at a low shear rate for a duration of 15 min, forming the rubberized asphalt blend.

### Example 3

A mixture of 75 parts by weight (pbw) and 15 pbw KRATON™ D1118 is mixed at temperature of 160° C. at a high shear rate for a duration of 2 hours to produce a rubberized asphalt mixture. Then, the temperature of the rubberized asphalt mixture was reduced to 140° C., and 10 pbw of acResin® A-204 was stirred into the mixture at a low shear rate for a duration of 15 min, forming the rubberized asphalt blend.

### Comparative Example 1

A mixture of 75 parts by weight (pbw) and 25 pbw KRATON™ D1118 is mixed at temperature of 160° C. at a high shear rate for a duration of 2 hours to produce a rubberized asphalt mixture.

The samples were evaluated using the following test methods: Peel strength testing according to PSTC (Pressure Sensitive Tape Council) 101 and PSTC #7 Holding Power of PS tapes for shear strength using 1.27 cm (½ in)×1.27 cm (½ in) or 2.54 cm (1 in)×2.54 cm (1 in) overlap and a 1 kg weight, with a stainless steel (SS) substrate. The compositions of examples 1 to 3 and of the comparative example 1 were secured to a stainless steel panel and to an HDPE panel, and the test specimen subjected to peel strength testing according to PSTC 101. The results of these evaluations are summarized in table 1.

TABLE 1

| | Comp. Ex. | Ex. 1 | Ex. 2 | Ex. 3 |
|---|---|---|---|---|
| 180 Peel (HDPE) CTH | 6.05 | 5.39 | 6.93 | 7.82 |
| 180 Peel (SS) CTH | 6.15 | 6.28 | 7.44 | 7.82 |
| 180 Peel (HDPE) 0° C. | 4.02 | 2.97 | 11.32 | 8.05 |
| 180 Peel (SS) 0° C. | 2.20 | 2.41 | 8.32 | 8.84 |
| Loop Tack (SS) | 4.17 | 2.82 | 10.10 | 14.55 |
| Shears 1 × 1 × 1 Kg | 784.00 | 27.67 | 410.67 | 349.00 |

The data will demonstrate the usefulness of the present invention. Though is apparent that Example 1 does not show improved performance, this example demonstrates that the chemical nature of the asphalt and that of the acrylic copolymer have to be closely matched as follows to obtain superior results. The reduced shear of Ex.1 to 3 over the comparison is a trade-off to the CTH (controlled temperature and humidity at 75F, 80% relative humidity) peel off HDPE and 0° C. peel off HDPE which are significantly increased. To achieve higher peel off HDPE, the modified rubberized asphalt must have much better flow, and the shear or cohesive strength is expected to be somewhat reduced while still being within a range of shear value that is acceptable for commercial applications, such as roofing. It is within the scope of the scope of this invention to replace, for example, part or all of an SBS type modifier with one of a higher styrene content or higher molecular weight to offset this loss, depending on the specific needs of the application.

Examples 2 and 3 demonstrate the peel strength at greater than 6 lbs/in, or greater than 8 lbs/in. The significant and surprising improvement of peel strength at 0° C., i.e. adhesion at low temperatures that prevent leakage of the ice dam during snow melt.

Various modifications and alterations that do not depart from the scope and spirit of this invention will become apparent to those skilled in the art. This invention is not to be duly limited to the illustrative embodiments set forth herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The term “substantially all of” means an amount or area coverage of 80% or more and is merely intended to serve as a shorthand method of referring individually to each separate value falling within the range from 80% to 100%.

Preferred embodiments of this invention are described herein, including the best mode known to the inventors for carrying out the invention. It should be understood that the illustrated embodiments are exemplary only, and should not be taken as limiting the scope of the invention.

1.-29. (canceled)

30. A composition comprising:
an acrylic copolymer,
n elastomeric polymer,
and asphalt.

31. The composition of claim 30, wherein the elastomeric polymer is a thermoplastic elastomer.

32. The composition of claim 31, wherein the elastomeric polymer is selected from the group consisting of styrene-butadiene copolymer, styrene-butadiene rubber, Polyethylene/polypropylene, ethylene acrylate copolymer, ethyl-vinyl-acetate (EVA), polyvinyl chloride (PVC), ethylene propylene, Polychloroprene latex, natural latex, and polyolefins.

33. The composition of claim 31, wherein the asphalt has a penetration of from 30 to 300 determined according to ASTM D5.

34. The composition of claim 30, wherein the composition comprises from 5% to 20% by weight elastomeric polymer, from 60% to 90% by weight asphalt, and from 5% to 20% by weight acrylic copolymer, based on total weight of the composition.

35. The composition of claim 30, wherein the acrylic copolymer is based on a polymerization of a monomer A, a monomer B, and a monomer C.

36. The composition of claim 30, wherein the acrylic copolymer has a weight average molecular weight Mw of from 150,000 to 250,000.

37. The composition of claim 30, wherein the acrylic copolymer has a number average molecular weight Mn of from 20,000 to 50,000.

38. The composition of claim 30, wherein the acrylic copolymer has a dispersity of from 5 to 11.

39. The composition of claim 35, wherein monomer A includes methyl, ethyl, propyl, isoamyl, isooctyl, n-butyl, isobutyl, tert-butyl, cyclohexyl, 2-ethylhexyl, decyl, lauryl or stearyl acrylate and/or methacrylate.

40. The composition of claim 35, wherein monomer B includes acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and -methacrylamide, maleic acid monoamide and diamide, itaconic acid monoamide and diamide, fumaric acid monoamide and diamide, vinylsulfonic acid or vinylphosphonic acid.

41. The composition of claim 35, wherein monomer C includes N,N-dimethylaminoethyl- and N,N-diethylaminoethyl(meth)-acrylamide,N,N-diisopropyl(meth)acrylamide,N,N-dibutyl(meth)acrylamide, N,N-dimethylaminoethyl (meth)acrylate and N,N-diethylaminoethyl (meth)acrylate, dimethyl- and diethylaminoethyl vinyl ether, N-vinylimidazole, N-vinylimidazoline, vinylpyridines, dialkyl(meth)acrylamides, N-vinylformamide, N-vinylpyrrolidone, N-vinylcaprolactam, p-hydroxy(meth)acrylic acid anilide, N-tert-butyl(meth)-acrylamide, diacetone(meth)acrylamide, N-(1-methylundecyl) (meth)acrylamide, N-isobornyl(meth)acrylamide, N-adamantyl(meth)acrylamide, N-benzyl(meth)acrylamide, N-4-methylphenyl(meth)acrylamide, methyl(meth)acrylamide, N-diphenylmethylacrylanide, phthalimidomethyl(meth)acrylamide, (meth)acrylamidohydroxyacetic acid, (meth)acrylamidoacetic acid, (meth)acrylamidoacetic esters, such as methyl (meth)acrylamidoacetate, 2-(meth)acrylamido-2-methylbutyric acid, N-(2,2,2-trichloro-1-hydroxy)-ethyl(meth)acrylamide, N,N-bis-(2-cyanoethyl)-methacrylamide, N-(1,1,1-trishydroxymethyl)(meth)acrylamide, methyl-(meth)acrylamide and N-(3-hydroxy-2,2-dimethylpropyl)(meth)acrylamide, 2-hydroxy-3-[N,N-di-(2-hydroxyethyl)]-propyl (meth)acrylate, 2-methoxy-3-[N,N-di-(2-hydroxyethyl)]-propyl (meth)acrylate, 2-hydroxy-3-[N-hydroxyethyl-N-alkyl]-propyl (meth)acrylates, 2-hydroxy-3-[N,N-dialkyl]-propyl (meth)acrylate, 2-hydroxy-3-[N-hydroxyethyl-N-methyl]-propyl (meth)acrylate and 2-hydroxy-3-[N-ethyl-N-methyl]-propyl(meth)acrylate, 3-cyclohexylprop-1-yl (meth)acrylate, cyclohexyl (meth)acrylate, 4-tert-butylcyclohexyl (meth)acrylate, 2-N-morpholinoethyl (meth)acrylate, 2-N-morpholinohexyl (meth)acrylate, furfuryl (meth)acrylate, isobornyl (meth)acrylate, N-cyclohexyl(meth)acrylamide and N-isobornyl(meth)acrylamide.

42. The composition of claim 35, wherein the monomer A is selected from the group consisting of 2-ethylhexyl acrylate, butyl acrylate, and isooctyl acrylate, wherein the acrylate monomer has a Tg of less than −30 C by DSC, in an amount of from 50% by weight to 99.99%/o by weight.

43. The composition of claim 35, wherein the monomer B is selected from the group consisting of acrylic acid, methacrylic acid, and itaconic acid, in an amount of from 0.1% by weight to 10% by weight.

44. The composition of claim 35, wherein the monomer C is selected from the group consisting of glycidyl methacrylate, maleated acrylate, and hydroxyl ethyl acrylate, in an amount of from 0.1% by weight to 25% by weight.

45. An underlayment comprising a substrate and an acrylic copolymer and a binder.

46. The underlayment of claim 45, further comprising a release liner.

47. The underlayment of claim 46, wherein the substrate is selected from the group consisting of nonwoven polypropylene, nonwoven polyethylene, nonwoven polyethylene terephthalate, woven polypropylene, woven polyethylene, spunbond polypropylene, spunbond polyester, and combinations thereof.

48. The composition of claim 30, where the composition is characterized by a peel strength, when adhered to a stainless steel panel and tested according to PSTC 101, of at least 5 psi.

49. A roof assembly comprising the underlayment of claim 46.

50. A process for producing composition of claim 30 comprising mixing the elastomeric polymer and the asphalt at a temperature above about 1500 C at a high shear rate for a duration of more than 1 hour to produce a rubberized asphalt mixture, reducing the temperature of the rubberized asphalt mixture to a temperature of about 140° C., mixing, at a low shear rate for a duration of more than 10 min, the acrylic copolymer to the rubberized asphalt mixture to form an rubberized asphalt blend.

51. The process of claim 50, wherein the rubberized asphalt blend comprises from 5% to 20% elastomeric polymer, from 60% to 90% asphalt, and from 5% to 20% acrylic copolymer, based on total weight of the rubberized asphalt blend.

52. The process of claim 50, wherein the acrylic copolymer is based on a polymerization of a monomer A, a monomer B, and a monomer C.

53. The process of claim 50, wherein the acrylic copolymer has a weight average molecular weight Mw of from 150,000 to 250,000.

54. The process of claim 50, wherein the acrylic copolymer has a number average molecular weight Mn of from 20,000 to 50,000.

55. The process of claim 50, wherein the acrylic copolymer has a dispersity of from 5 to 11.

56. The process of claim 52, wherein the monomer A is selected from the group consisting of 2-ethylhexyl acrylate, butyl acrylate, and isooctyl acrylate, wherein the acrylate monomer has a Tg of less than −30 C by DSC, in an amount of from 50% by weight to 99.99% by weight.

57. The process of claim 52, wherein the monomer B is selected from the group consisting of acrylic acid, methacrylic acid, and itaconic acid, in an amount of from 0.1% by weight to 10% by weight.

58. The process of claim 52, wherein the monomer C is selected from the group consisting of glycidyl methacrylate, maleated acrylate, and hydroxyl ethyl acrylate, in an amount of from 0.1% by weight to 25% by weight.
